(19) United States
(12) Patent Application Publication
(10) Pub. No.: US 2012/0328950 A1
(43) Pub. Date: Dec. 27, 2012

(54) PROCESS FOR THE PREPARATION OF FINELY DISPERSED LITHIUM TITANIUM SPINELS AND THEIR USE

(75) Inventors: Stefanie Busl, Halibergmoos (DE); Genovefa Wendrich, Essenbach (DE); Jasmin Dollinger, Landshut (DE); Michael Holzapfel, Kehl (DE); Nicolas Tran, Nandlstadt (DE)

(73) Assignee: Sud-Chemie AG, München (DE)

(21) Appl. No.: 13/502,277

(22) PCT Filed: Sep. 28, 2010
(86) PCT No.: PCT/EP2010/005915

§ 371 Date: Aug. 30, 2012

(30) Foreign Application Priority Data
Oct. 15, 2009 (DE) 10 2009 049 470.7

(51) Int. Cl. C01G 23/04; B01F 9/00; B01F 15/06; H01M 4/131

(52) U.S. Cl. 429/231.1; 366/231; 366/145; 423/598

(57) ABSTRACT

The present invention relates to a process for the preparation of a mixture for producing lithium titanium spinel Li₄Ti₅O₁₂, having the step of mixing Li₂CO₃ and TiO₂ in a vessel (1) in which at least one oblong element (2) with a first end (2a) and a second end (2b) is arranged such that the first end (2a) points towards an inner wall (1a) of the vessel (1) and is at a distance d from same, wherein the mixing step is carried out by allowing the vessel (1) to rotate and holding the oblong element (2) in its position, with the result that a relative movement takes place between the inner wall (1a) of the vessel (1) and the first end (2a) of the oblong element (2), wherein the distance d is kept constant during mixing. In addition, the invention relates to a process for the preparation of lithium titanium spinel Li₄Ti₅O₁₂ from a thus-obtained mixture and its use as anode material in rechargeable lithium-ion batteries.

### CROSS-REFERENCE TO RELATED APPLICATIONS

This application is a U.S. National Stage application claiming benefit of International Application No. PCT/EP2010/005915, filed Sep. 28, 2010, and claiming benefit of German Application No. DE 10 2009 049 470.7, filed Oct. 15, 2009. The entire disclosures of both PCT/EP2010/005915 and DE 10 2009 049 470.7 are incorporated herein by reference.

### BACKGROUND

The present invention relates to a process for the preparation of a mixture for producing doped and non-doped lithium titanium spinels Li₄Ti₅O₁₂ as well as the further processing of this mixture to finely dispersed doped and non-doped lithium titanium spinels.

Lithium titanium spinel Li₄Ti₅O₁₂ is being increasingly widely used as anode material in rechargeable lithium-ion batteries. For this use it is desirable that the lithium titanium spinel is as finely dispersed as possible, i.e. has a small particle size. Such finely dispersed lithium titanium spinel is preferred in battery manufacture because the fineness of the grain makes possible good electrochemical properties such as high capacity and rapid chargeability/dischargeability.

One possibility for the preparation of lithium titanium spinel Li₄Ti₅O₁₂ consists of a solid-state reaction between a titanium compound, typically TiO₂, and a lithium compound, typically Li₂CO₃, at high temperatures. Here, the starting materials are mixed mechanically and then sintered in the named high-temperature step. However, the originally small (anatase) crystallites of the TiO₂ increase markedly due to the high temperatures during the sintering process. Such a process is described for example in U.S. Pat. No. 5,545,468. Due to the growth, primary particles that are too coarse are obtained according to that process, for which reason the thus-obtained product must be laboriously ground.

With regard to the grinding, either the starting materials (for example Li₂CO₃ and TiO₂) and/or the end product obtained after the sintering can be ground, for example using a ball mill. However, this step is cost-intensive and also often results in impurities due to abrasion.

In addition, as a result of the high temperatures during sintering, by-products or phase changes such as e.g. from anatase to rutile which remain in the product often form, see e.g. EP 1 722 439 A1. It is therefore desirable to reduce the sintering temperatures without thereby impairing the sintering process.

According to other processes, more strongly reactive starting materials such as for example lithium hydroxide are therefore used for the preparation of Li₄Ti₅O₁₂. The temperatures required for the sintering procedure can thereby be reduced, wherein however problems with regard to possible corrosion of the vessel materials can arise due to the higher reactivity.

Syntheses have also been described which start from organotitanium compounds such as for example titanium isopropylate or titanium tetrabutylate, which already contain the titanium in a more reactive, as finely dispersed, form. Such a process is disclosed for example in DE 103 19 464 A1. However, the starting compounds of that process are much more expensive than TiO₂. The use of organic solvents can also constitute a problem, likewise the organic waste products (for example butanol or isopropanol) which form during the process. Finally, the titanium content of these starting compounds is also lower than that of TiO₂, with the result that a preparation of lithium titanium spinel using the described process is usually uneconomic.

Other processes start from TiCI₄, but this also is very corrosive and therefore makes great demands on the equipment used for production. In addition, traces of chloride which can later lead to problems in the battery, such as e.g. the corrosion of the foil conductor, often remain in the material.

### SUMMARY

There was therefore a need to provide a process by which a starting mixture for the production of doped or non-doped finely dispersed lithium titanium spinel can be prepared with low production costs.

Surprisingly, it was found that finely dispersed doped or non-doped lithium titanate spinel Li₄Ti₅O₁₂ can be produced by using as starting material a mixture which contains a lithium compound and TiO₂, and is obtained using the following process: mixing the lithium compound and TiO₂ in a vessel in which at least one oblong element with a first end and a second end is arranged such that the first end points towards an inner wall of the vessel and is at a distance d from same, wherein the step of mixing is carried out by allowing the vessel to rotate and holding the oblong element in its position, with the result that a relative movement takes place between the inner wall of the vessel and the first end of the oblong element, wherein the distance d is kept constant during mixing. Alternatively, the vessel can also remain at rest and the oblong element inside the vessel execute a circular movement.

A similar process is described for example in WO 01/44113. However, here a housing containing a manganese compound is made to rotate, wherein an oblong element is held in its position in the housing. However, this process takes place accompanied by the targeted supply of heat in order to achieve an aggregation of microparticles and control the shape of the aggregated particles.

According to the invention, it is understood that the term lithium titanate includes according to the invention all lithium titanate spinels according to the invention of the type Li₁₊ₓTi₂₋ₓO₄ with 0≦x≦1/3 of the space group Fd3m and generally also any mixed lithium titanium oxides of the generic formula LiₓTi_{y}O (0<y, y<1).

According to the invention, any lithium compound such as Li₂O, LIOH, lithium acetate, oxalate, nitrate, sulphate, or carbonate can be used as lithium compound. Lithium carbonate is the most cost-favourable lithium compound and therefore most preferred.

On the other hand, it is desired within the framework of the present invention to specifically avoid an aggregation of such microparticles. Instead, according to the invention a finely dispersed starting material for the preparation of lithium titanium spinel is to be obtained. It is therefore surprising that the process known from WO 01/44113 can be used in modified form to produce a fine-grained mixture containing a lithium compound and TiO₂.

Due to the rotation of the vessel, the starting substances, i.e. the lithium compound and TiO₂, are pressed against the inner wall of the vessel by the occurring centrifugal forces and thus enter the crack defined by the oblong element and the inner wall of the vessel, where they are pulverized and mixed together as a result of the relative movement between the vessel and the oblong element. A finely powdered, strongly homogeneous mixture is thereby obtained which makes possible a further processing to lithium titanium spinel without a separate intercalated grinding step.

### DETAILED DESCRIPTION

When an “oblong element” is mentioned within the framework of the invention, this is understood to mean any element the measurements of which in one dimension, here called “longitudinal direction”, are greater than twice its measurements in a further dimension, here called “thickness direction”. This can be both a rod-shaped element and a leaf-shaped or lamellar element.

Preferably, the TiO₂ is used in its anatase modification within the framework of the process according to the invention.

According to a preferred embodiment of the invention, the rotation of the vessel is carried out at a rotation frequency of between approximately 20 Hz and approximately 60 Hz. Thus the power which is supplied to the vessel and its contents through the rotation drive is relatively low. Thus the inner energy and accordingly the temperature of the mixture can be kept relatively low, with the result that little or no mechanical fusion or caking of particles takes place. The fine dispersion of the powder structure is thereby improved.

It has been shown that particularly satisfactory results in respect of fineness of dispersion and thorough mixing of the starting materials are obtained when the vessel or in the alternative embodiment the oblong element is rotated at a rotation frequency of between approximately 20 Hz and approximately 40 Hz.

The duration of the mixing step can be chosen depending on what is required of the material. It has proved favourable if the mixing step takes place over a period of between 5 min and 60 min. It is to be noted in this context that as the mixing duration increases the inner energy of the mixture and thus its temperature also rises. The previously mentioned mechanical fusion of particles or agglomerations can thereby result, which would impair the homogeneity of the mixture.

A duration of between 5 and 15 min for the mixing procedure has proved particularly suitable in this regard. However, it must be mentioned that the rotation rate of the vessel that is used is also to be taken into account in respect of the duration chosen for the mixing process. Thus lower rotation frequencies of the rotation generally necessitate a longer mixing time.

In order to limit the mentioned temperature increase due to the inner energy of the mixture during the treatment, according to one embodiment of the invention the temperature of the vessel and/or the temperature of the oblong element is kept at 50° C. or less. In other words, the vessel and/or the oblong element is subjected to a cooling, with the result that if the inner energy of the mixture increases, which takes place during the mixing process, an increase in temperature of the mixture can be limited or completely prevented by dissipating the heat energy. This embodiment is advantageous in particular if longer mixing times are chosen.

With regard to the type of cooling, suitable methods are known to a person skilled in the art in the field of mechanical engineering and therefore need not be described in detail here. The possibility may be mentioned merely by way of example of placing a cooling jacket around the outer housing wall through which cooling jacket a cooling fluid flows. Similarly, for example the oblong element can also be provided with a casing inside which the cooling fluid, in particular a cooling liquid, is circulated. Alternatively, the cooling can also be carried out by passing coolant through an inner cavity of the oblong element.

In this way, it is also possible to keep the temperature of the vessel and/or of the oblong element below 35° C. In this embodiment of the invention, the heat generated during the mixing process can be removed particularly well.

In order to keep the temperature of the housing and/or of the oblong element at or below the named values, for example thermal sensors can be used, in order to monitor the temperature of the vessel and/or of the oblong element, wherein the outputs of the thermal sensors can be fed in known manner to a regulator in order to automatically adjust the temperature of the vessel and/or of the oblong element to the desired pre-set value.

The first end of the oblong element, which points towards the inner wall of the vessel, is preferably at a fixed distance d of a few mm from this wall. In particular, this distance d is between 2 and 5 mm, wherein the range between 2 and 3 mm is particularly preferred. The actual grinding and mixing process takes place in the gap defined by the first end of the oblong element and the inner wall of the vessel, wherein various forces act on the starting materials of the mixture, in particular centrifugal force, shearing forces, friction forces and similar.

In addition to the already named starting materials of the lithium compound, such as e.g. Li₂CO₃and TiO₂, a carbon-containing compound such as carbon black, e.g. Ketjen Black, acetylene black etc. or a carbon precursor such as lactose, a polymer, starch etc., which decomposes into carbon upon sintering, can also be added to the vessel for the mixing step. During the subsequent further processing of the mixture prepared according to the invention to lithium titanium spinel, the carbon black or the carbon-containing compound speeds up the reaction through combustion in the subsequent sintering step, which will also be described below. The portion of admixed carbon black or carbon-containing compound is preferably between 15 wt.-% and 20 wt.-%, preferably between 5 and 10 wt.-%, quite particularly preferably between 5 and 7 wt.-% of the whole mixture.

The invention also relates to a mixture containing a lithium compound, in particular Li₂CO₃, and TiO₂, which is prepared according to the above process, wherein the primary particle size d₉₀ of the mixture is less than or equal to 1 μm.

If doped lithium titanium spinel is to be prepared by means of the process according to the invention, a metal compound (doping metal), preferably an oxide or a carbonate, acetate or oxalate, is additionally added to the lithium compound and the TiO₂. The metal of the metal compound is selected from Sc, Y, Al, Mg, Ga, B, Fe, Cr, Mn, V, preferably Al, Mg, Ga and Sc, quite particularly preferably Al. The doping metal cations which can sit on lattice sites of either the titanium or the lithium are preferably present in a quantity of from 0.05 to 3 wt.-%, preferably 1-3 wt.-%, relative to the total spinel.

The mixture prepared according to an embodiment of the process according to the invention can be used for example as starting material for the preparation of lithium titanium spinel. This does not require an additional grinding step because, as already mentioned, the mixture has already been prepared with extremely small primary particle size using the process according to the invention. In this way the impurities which normally occur during grinding, for example as a result of abrasion processes in a ball mill, can be prevented or reduced.

The invention also relates to a process for the preparation of finely dispersed lithium titanium spinel starting from the above-named mixture, wherein the process comprises the sintering of the mixture. Sintering is a high-temperature process as a result of which the starting products contained in the mixture react to Li₄Ti₅O₁₂.

Due to the already mentioned high quality of the starting mixture which is obtained during the process described above, it is sufficient for the sintering step to take place at a temperature of between 800° C. and 850° C. A temperature range of between 820° C. and 850° C. is particularly preferred. Compared with the conventional processes with Li₂CO₃ and TiO₂ as starting materials for the preparation of lithium titanium spinel, in which sintering temperatures of ≧900° C. are necessary, a marked reduction in the sintering temperature is thus made possible, which brings with it a saving in both energy and cost. In addition, the risk of corrosion of the vessels used is also thereby reduced.

The primary particles of the lithium titanium spinel obtained according to the invention typically have a diameter of 390-500 nm. This means that lithium titanium spinel with an extremely small particle size can be produced according to the process, which means that the load capacity in an anode which contains the lithium titanate material according to the invention is particularly high. In addition, such an anode has a high cycle stability.

The duration preferably used for the sintering step in the process according to the invention is between 12 and 18 hours, in particular between 15 and 17 hours. It was shown within the framework of such a sintering step that phase-pure lithium titanium spinel can be obtained.

According to the invention, the term “phase-pure” or “phase-pure lithium titanate spinel” means that no rutile phase can be detected in the end product by means of XRD measurements within the limits of the usual measurement accuracy. In other words, the lithium titanate spinel according to the invention is rutile-free in this preferred embodiment.

As already mentioned, the described small particle size can be obtained without additional intensive grinding of the starting products or of the end product in a process according to preferred embodiments of the present invention. However, it may be necessary to comminute by means of brief grinding processes any agglomerates present of the primary particles, such as can be carried out e.g. with a ball mill. A process step required according to the state of the art to produce finely dispersed lithium titanium spinel can thereby be dispensed with, which saves time and costs. Of course, the product obtained can also be ground even more finely, should this be necessary for a specific use. The grinding process is carried out using methods known per se to a person skilled in the art.

Preferably, the doped or non-doped lithium titanate spinel prepared according to the invention is used as anode material in rechargeable lithium-ion batteries.

Thus, the present invention also relates to a rechargeable lithium-ion battery comprising an anode and cathode plus an electrolyte, wherein the anode contains lithium titanate spinel Li₄Ti₅O₁₂ prepared according to the invention.

The anode according to the invention has a specific charge/discharge capacity of >150 Ah/kg at a rate of 20 C.

The invention is described in more detail below with reference to figures and embodiment examples which are not, however, to be considered limiting.

### BRIEF DESCRIPTION OF THE DRAWINGS

There are shown in:

FIG. 1 a device which can be used when carrying out a process according to the invention;

FIGS. 2a-2b diagrams of the cycle stability of an Li₄Ti₅O₁₂ prepared according to a process according to the invention as anode material and an Li₄Ti₅O₁₂ prepared according to a process of the state of the art as anode material;

FIGS. 3a-3c REM photographs of a mixture prepared according to the invention of Li₂CO₃ and TiO₂ with different vessel temperatures as well as an analogous mixture which was prepared according to the state of the art;

FIGS. 4a-4e REM photographs of lithium titanium spinel prepared according to the invention with and without cooling of the vessel as well as of a comparison product prepared according to a process of the state of the art

FIGS. 5a-5c diagrams of the cycle stability of an Li₄Ti₅O₁₂ prepared according to a process according to the invention as anode material and an Li₄Ti₅O₁₂ prepared according to a process of the state of the art as anode material;

FIGS. 6a-6b REM photographs of a mixture prepared according to the invention of Li₂CO₃, TiO₂ and carbon black as well as an analogous mixture which was prepared according to the state of the art.

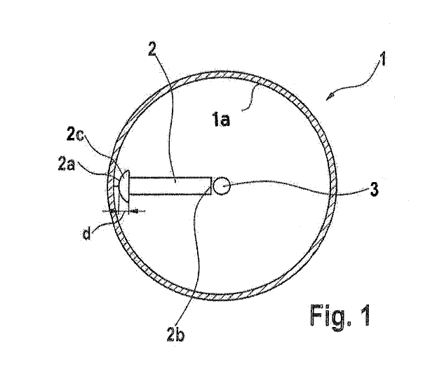

FIG. 1 shows a schematic cross-section view through a device as can be used when carrying out a process according to the invention.

The device comprises a vessel 1 with an inner wall 1a. The vessel is essentially rotation-symmetrical.

Located within the vessel 1 is an oblong element 2, here a rod-shaped element, with a first end 2a which points towards the inner wall 1a of the vessel 1, as well as a second end 2b. The oblong element 2 can be fixed at this second end 2b, for example at a fixed shaft 3. In this way, the oblong element 2 remains stationary during a rotation of the vessel about its shaft 3.

The first end 2a, pointing towards the vessel wall 1a, of the oblong element 2 can be provided with a shoe 2c which has a convex, for example a hemispherical, surface in order to facilitate the drawing-in of particles of the material to be mixed, here Li₂CO₃ and TiO₂. The shoe 2c or the first end 2a defines together with the nearest part of the housing inner wall 1a a gap of thickness d, within which the starting materials are exposed to various forces, in particular shearing and friction forces, upon rotation of the vessel 1.

If the vessel rotates about the shaft 3, the starting materials are pressed against the inner wall 1a of the vessel by centrifugal force. At the level of the (stationary) first end 2a of the oblong element 2, the material is mixed and pulverized by the forces occurring in the region of the gap. It is to be noted that, although only a single oblong element 2 is shown in the figure, several such elements can be present which are arranged for example radially and at equal distances about the shaft 3.

A cooling device (not shown) can be present in order to cool the outer wall of the vessel 1 and/or the oblong element 2 or a part thereof, for example the shoe 2c, or in order to remove the heat generated during the process according to the invention.

### Embodiment Examples

1. Preparation of a mixture of Li₂CO₃ and TiO₂

a) 218.97 g TiO₂ and 82.68 g (air-jet ground) Li₂CO₃ were introduced into a device of the type described above. The device was a Hosokawa Alpine AMS Lab type apparatus with 1.21 useful capacity (corresponding to approx. 600 g to 700 g of the material composition named above). The distance between the stator (corresponding to the oblong element) and the inner wall of the vessel was 3 mm. Approximately 440 g of the above-described composition of the starting materials was treated for 1 h without cooling at a power consumption of 1 kW. The temperature rose to up to 75° C. in the stator. The thus-obtained mixture was then sintered for 17 h at 850°. High-purity Li₄Ti₅O₁₂ was obtained.

On the other hand, a comparison product with the same starting materials was subjected to a conventional mixing. For this, a “Lodige” type mixer was used. Here, the sintering was carried out for 12 h at 950° C. High-purity Li₄11₅O₁₂ was not obtained.

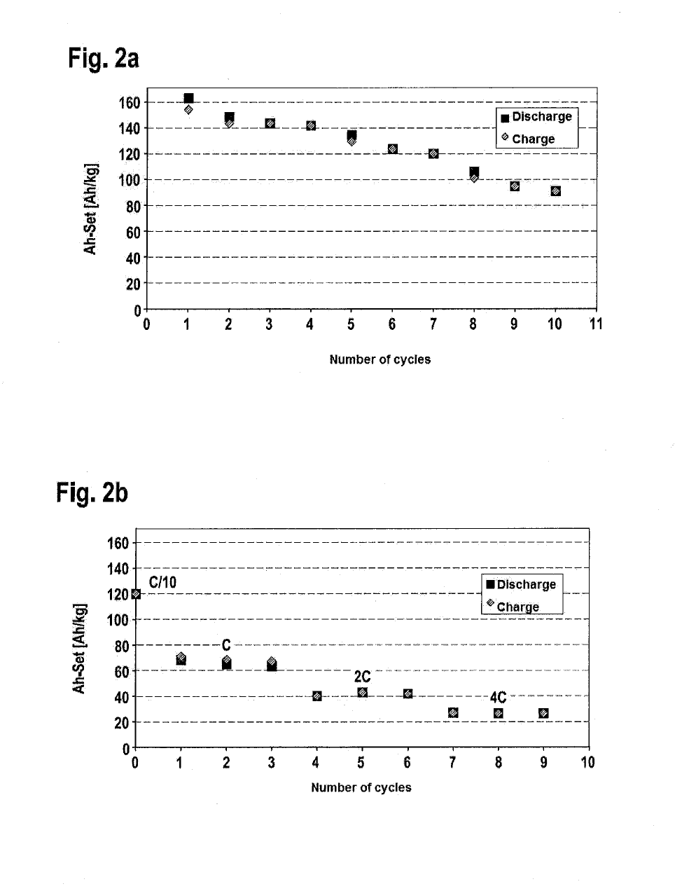

In each case, an anode was produced from the thus-prepared Li₄Ti₅O₁₂ and its cycle stability tested. The results can be seen in FIGS. 2a (product prepared according to the invention) and 2b (comparison product prepared according to the state of the art). As can be seen, the specific charge/discharge capacity that is achieved at C rate (1C) is up to 160 Ah/kg for the product prepared according to the invention, against a value of at most 110 Ah/kg for Li₄Ti₅O₁₂ which was prepared according to the state of the art.

b)A mixture of the same starting materials underwent a process according to the invention in a Hosokawa Alpine Nobilta type device with 0.51 useful capacity (corresponding to approx. 300 g of the material composition named above). In this case also, the distance between the blade (oblong element) and the vessel wall was 3 mm. The outer jacket of the housing was cooled in the process. It was thereby made possible to keep the temperature of the product below 75° C. after 5 min treatment duration at rates of rotation of up to 50 Hz. The rate of rotation was then varied between 10 and 50 Hz and the treatment duration between 5 min and 15 min.

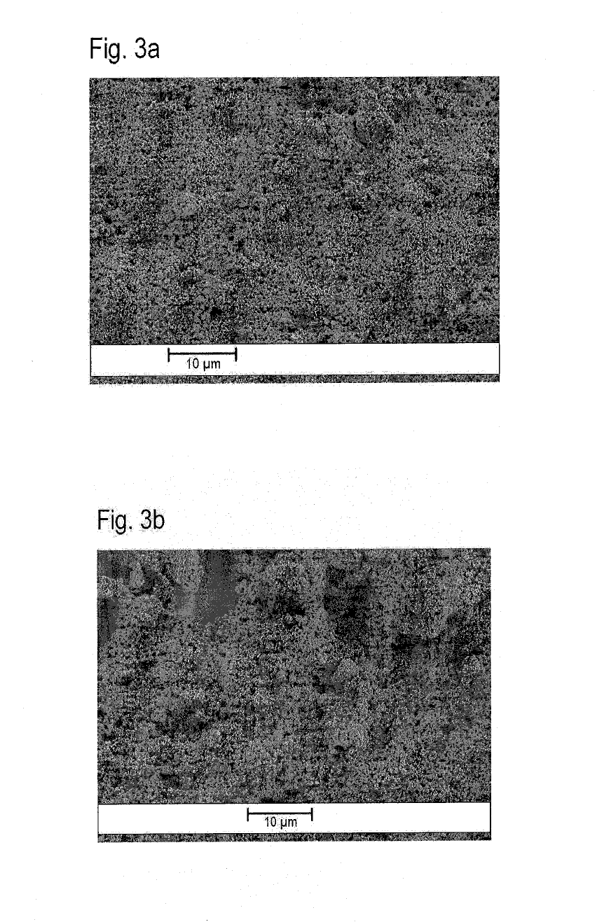

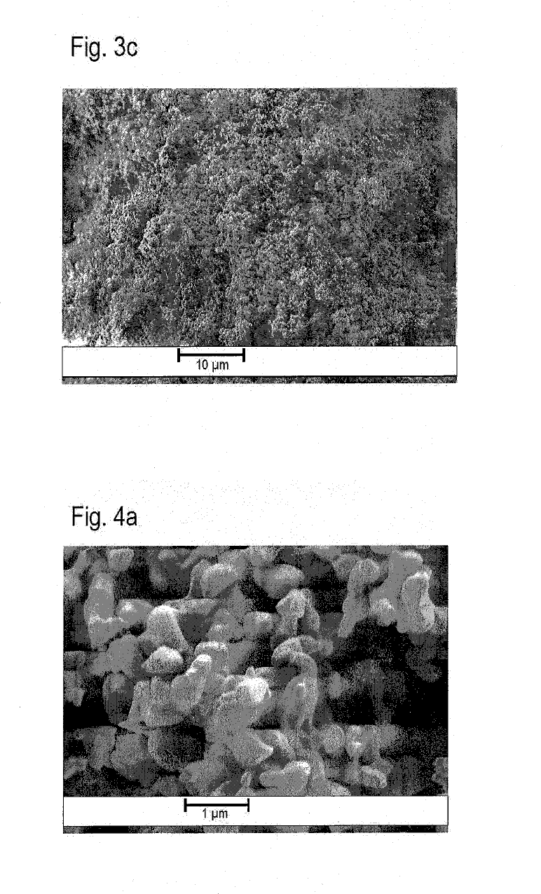

FIGS. 3a and 3b show REM photographs of mixtures of Li₂CO₃ and TiO₂ prepared according to the invention each treated for 10 min at a rotation frequency of 30 Hz. The mixture of FIG. 3a was introduced into a previously used apparatus which was already heated and the mixture from FIG. 3b into a cold apparatus. At the end of the treatment, the product temperature was 63° C. in the case of FIGS. 3a and 35° C. in the case of FIG. 3b.

As can be seen, the sample from FIG. 3b creates a more homogeneous impression, although both samples display a very much greater homogeneity than the comparison sample of the state of the art treated in a Lodige mixer.

Consequently, a better distribution of the two starting materials can be seen in the case of a mixture prepared according to a process according to the invention. In addition, the interaction between the anatase particles decreases and simultaneously the interaction between the anatase and the Li₂CO₃ increases. However, if the temperature of the products is too high this effect is reversed and the agglomeration of the anatase increases again, although no fusion takes place.

The thus-prepared mixtures were then sintered for 15 h at different temperatures. In the case of sintering at 800° C., there were no high-purity samples. However, the sample which was treated at 30 Hz for 10 min according to the process according to the invention displayed only minimal traces of impurities. In the case of sintering at 850° C., only high-purity products were obtained for samples produced according to the invention. In the case of sintering at 820° C., almost high-purity lithium titanium spinel was obtained for all time periods in the case of treatment at 20 Hz. The best results were achieved in the case of a treatment at a rotation frequency of 30 Hz to 40 Hz and a duration of 10 min.

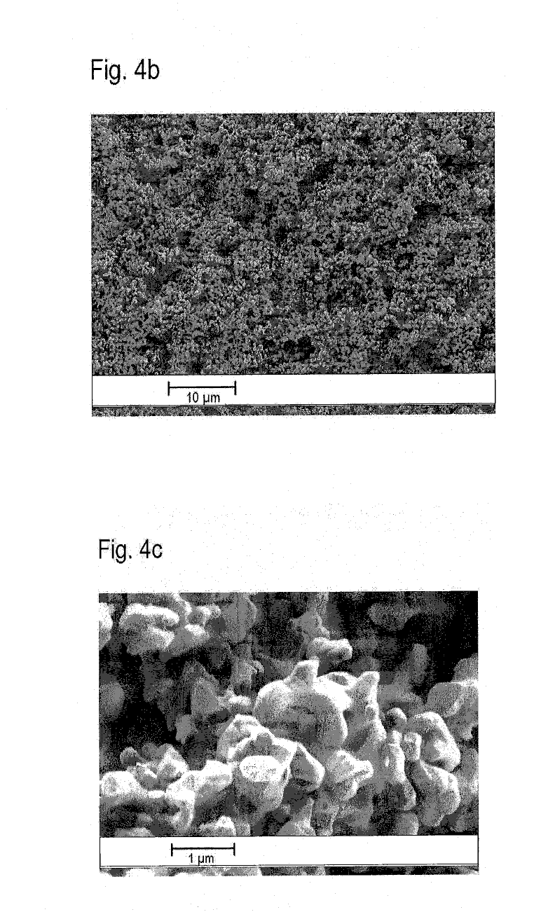

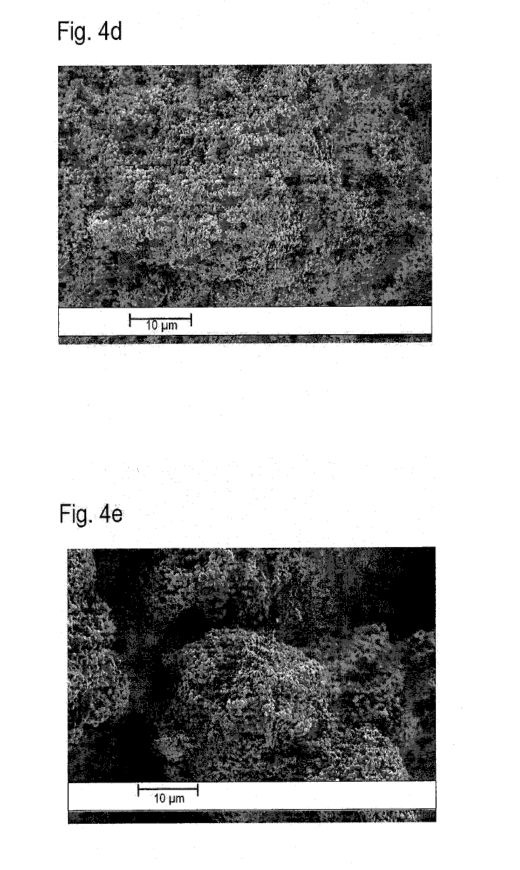

REM photographs of samples which were treated at 30 Hz for 10 min are shown in FIGS. 4a to 4d. FIGS. 4a and 4b show in various manifestations a sample which was introduced into a cold starting vessel, and FIGS. 4c and 4d a sample which was introduced into a vessel heated to 63° C.

A primary particle size of less than 1 μm was obtained in both cases, which shows an open-pored secondary structure. As can be seen, the product of FIGS. 4c and 4d displays a slightly greater fusion.

FIG. 4e shows a comparison product which was obtained according to WO 02/46109 in a magnification corresponding to those of FIGS. 4b and 4d. It is to be noted that this product was produced accompanied by admixing carbon black (in this process the reaction is accelerated by burning the admixed carbon black). A similarly open-pored structure, as in the cases of FIGS. 4a to 4d, can be seen.

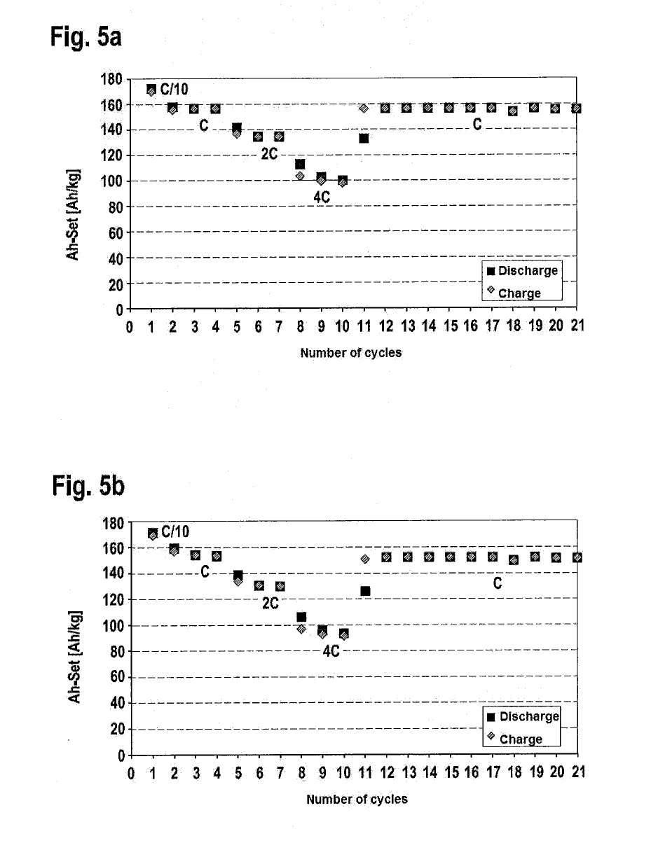

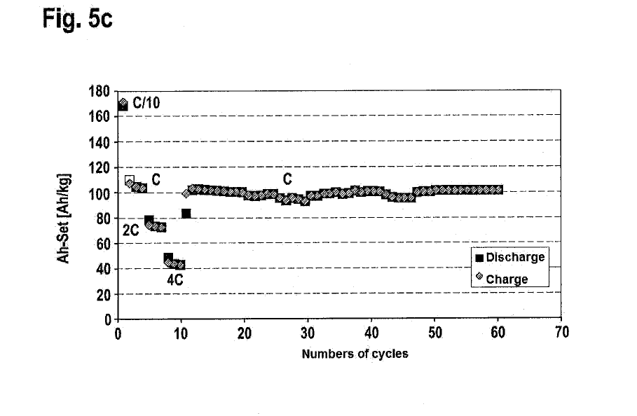

Furthermore, electrochemical load capacity tests with C rates of up to 4C were carried out. The result is shown in FIGS. 5a to 5c, wherein the behaviour of the sample from the cold vessel is shown in FIG. 5a and the behaviour of the sample from the warm vessel in FIG. 5b. FIG. 5c shows the behaviour of the comparison product.

It can be seen that the specific capacity of the lithium titanium spinel increases markedly as a result of the treatment according to the invention and almost reaches the theoretically possible value of 175 mAh/g in the embodiments of the invention. The current-carrying capacity also increases markedly. The effect which was to be expected on account of the homogeneity of the starting mixture achieved through the process according to the invention was thus confirmed.

Compared with this, the sample of the comparison product displays much poorer values.

### 2.Preparation of a Mixture of Li₂CO₃, TiO₂ and Carbon Black

168.68 g TiO₂, 66.57 g Li₂CO₃ and 14.75 g carbon black were introduced into the Hosokawa Alpine AMS type device with 1.21 useful capacity (corresponding to approx. 600 g to 700 g of the material composition named above). The distance between the stator (corresponding to the oblong element) and the inner wall of the vessel was again 3 mm. Approximately 440 g of the above-described composition of the starting materials was treated for ½ h without cooling at a power consumption of 900 W. The temperature rose to up to 75° C. in the stator.

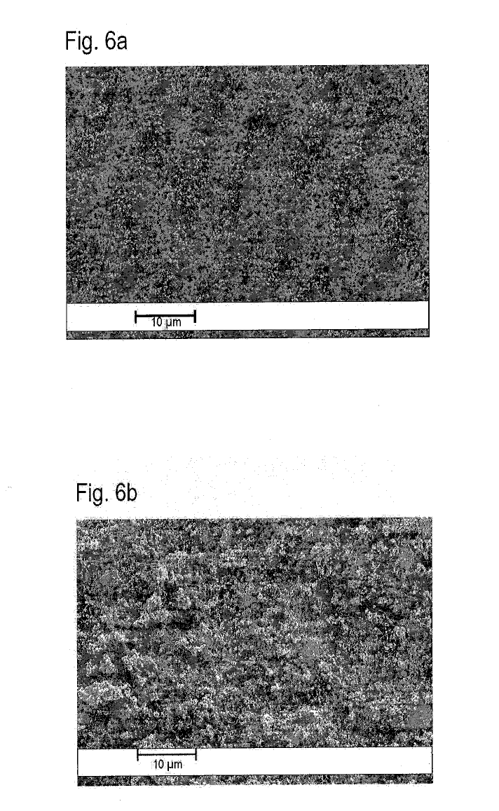

FIG. 6a shows an REM photograph of the thus-obtained mixture, while FIG. 6b displays in the same magnification a mixture of the same starting materials produced in a Lodige mixer according to a process of the state of the art. A very good homogeneous thorough mixing can be seen in FIG. 6a. Against this, a clear agglomeration of the anatase particles as well as a less than thorough mixing can be seen according to FIG. 6b in the case of the comparison product of the state of the art.

1. A process for the preparation of a mixture for producing lithium titanium spinel Li₄Ti₅O₁₂, comprising the step of mixing a lithium compound and TiO₂ in a vessel (1) in which at least one oblong element (2) with a first end (2a) and a second end (2b) is arranged such that the first end (2a) points towards an inner wall (1a) of the vessel (1) and is at a distance d from same, wherein the mixing step is carried out by allowing the vessel (1) to rotate and holding the oblong element (2) in its position, with the result that a relative movement takes place between the inner wall (1a) of the vessel (1) and the first end (2a) of the oblong element (2), wherein the distance d is kept constant during mixing.

2. The process according to claim 1, wherein the rotation of the vessel (1) takes place with a rotation frequency of between approximately 20 Hz and approximately 60 Hz.

3. The process according to claim 2, wherein the rotation of the vessel takes place with a rotation frequency of between approximately 20 Hz and approximately 40 Hz.

4. The process according to claim 1, wherein the mixing step is carried out over a period of between approx. 5 min and approx. 60 min.

5. The process according to claim 4, wherein the mixing step is carried out over a period of between approx. 5 min and approx. 15 min.

6. The process according to claim 1, wherein the temperature of the vessel (1) and/or of the oblong element (2) is kept at or below 50° C. during mixing.

7. The process according to claim 6, wherein the temperature of the vessel (1) and/or of the oblong element (2) is kept at or below 35° C. during mixing.

8. The process according to claim 1, wherein the distance d is kept between 2 mm and 5 mm.

9. The process according to claim 1, wherein the mixing step comprises the mixing of the lithium compound, TiO₂ and a carbon-containing compound.

10. The process according to claim 9, wherein a metal compound is further added in the mixing step.

11. A mixture obtained by a process according to claim 1, wherein the mixture displays a primary particle size of 1 μm or less.

12. A process for the preparation of lithium titanium spinet Li₄Ti₅O₁₂, comprising a step of sintering the mixture according to claim 11.

13. The process according to claim 12, wherein the sintering step is carried out at a temperature of between 800° C. and 850° C.

14. The process according to claim 13, wherein the sintering step is carried out at a temperature of between 800° C. and 820° C.

15. The process according to claim 12 to, wherein the sintering step is carried out over a period of between 12 and 18 h.

16. A method of preparing a reusable lithium-ion battery, comprising forming an anode from a lithium titanium spinel Li₄Ti₅O₁₂, prepared according to a process according to claim 12, as anode material for reusable lithium-ion batteries.

17. A rechargeable lithium-ion battery, comprising an anode, a cathode plus an electrolyte, wherein the anode contains lithium titanate spinel Li₄Ti₅O₁₂ prepared according to the process of claim 12.
